(19) United States
(12) Patent Application Publication
(10) Pub. No.: US 2015/0229548 A1
(43) Pub. Date: Aug. 13, 2015

(54) UNIVERSAL KEY PERFORMANCE INDICATOR FOR THE INTERNET OF THINGS

(71) Applicant: Feeney Wireless, LLC, Eugene, OR (US)

(72) Inventors: Robert E. Ralston, Eugene, OR (US); Justin D. Bloom, Eugene, OR (US)

(21) Appl. No.: 14/616,694

(22) Filed: Feb. 7, 2015

Related U.S. Application Data
(60) Provisional application No. 61/938,016, filed on Feb. 10, 2014.

(51) Int. Cl. H04L 12/26

(52) U.S. Cl. CPC H04L 43/065; H04L 43/10

(57) ABSTRACT

Embodiments include a universal key performance indicator engine associated with an Internet of Things. The universal key performance indicator engine can include a control logic section, a mining logic section to mine for device factors, network factors, and/or application factors associated with a subset of devices within the Internet of Things, and a universal key performance indicator logic section to generate a universal key performance indicator associated with the subset of devices based at least on the mined factors. The universal key performance indicator can be transmitted to a remote server and/or to an administrator of a network. When the universal key performance indicator crosses a predefined threshold, an alert or recommendation can be made to improve the operability, security, and performance of devices within the Internet of Things.

### RELATED APPLICATION DATA

This application claims the benefit of commonly owned U.S. provisional patent application Ser. No. 61/938,016, filed on Feb. 10, 2014, which is hereby incorporated by reference.

### FIELD OF THE INVENTION

This application pertains to managed services, and more particularly, to methods and systems for providing and using a universal key performance indicator for machine-to-machine (M2M) solutions associated with the Internet of Things.

### BACKGROUND

It is projected that the Internet of Things will include tens of billions of devices in the not-too-distant future. Whereas before, computers were almost entirely dependent on human beings for operation, efforts to advance technology have led to devices that continually evolve and become more autonomous over time, to the point where the devices themselves become active participants in the network. The ‘things’ can have their own identity on the network, their own physical attributes, communications links, and even their own virtual personalities. There is a shift underway in network technology from a person-to-person model and toward a machine-to-machine (M2M) infrastructure.

But even as the Internet of Things blossoms, humans still want to have insight into the operational status of the devices and the ability to exert control when needed. As the number of devices on the network rapidly increases, so too does the complexity in understanding and managing the network devices, administrator tools, and customer solutions.

Accordingly, a need remains for improved methods and systems for providing centralized awareness and management of solutions. Embodiments of the invention address these and other limitations in the prior art.

### BRIEF DESCRIPTION OF THE DRAWINGS

FIG. 1 illustrates a schematic diagram of the Internet of Things and associated universal key performance indicator (UKPI) engine in accordance with various embodiments of the inventive concept.

FIG. 2 illustrates a schematic diagram of the Internet of Things and the associated UKPI engine configured to mine device factors including environmental, configuration, and hardware device factors in accordance with various embodiments of the inventive concept.

FIG. 3 illustrates a schematic diagram of the Internet of Things and the associated UKPI engine configured to mine network factors including capacity, performance, coverage, and routing/firewall network factors in accordance with various embodiments of the inventive concept.

FIG. 4 illustrates a schematic diagram of the Internet of Things and the associated UKPI engine configured to mine application factors including bandwidth requirements and data usage in accordance with various embodiments of the inventive concept.

FIG. 5 shows a flow diagram illustrating a technique for monitoring and adjusting a UKPI in accordance with embodiments of the invention disclosed herein.

The foregoing and other features of the invention will become more readily apparent from the following detailed description, which proceeds with reference to the accompanying drawings.

### DETAILED DESCRIPTION OF THE EMBODIMENTS

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first network could be termed a second network, and, similarly, a second network could be termed a first network, without departing from the scope of the inventive concept.

It will be understood that when an element or layer is referred to as being “on,” “coupled to” or “connected to” another element or layer, it can be directly on, directly coupled to or directly connected to the other element or layer, or intervening elements or layers may be present. In contrast, when an element is referred to as being “directly on,” “directly coupled to” or “directly connected to” another element or layer, there are no intervening elements or layers present. Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A network administrator has a particular “experience” when applying a given solution to one of a variety of problems that may be encountered when managing multiple things or devices within the Internet of Things. Given the increasing complexity and vastness of the Internet of Things, such experience can range from positive to negative, but can sometimes be neutral or somewhere in-between positive and negative. Customer experience for a given solution is affected by a variety of factors including device factors, network factors, and application factors. The term “administrator” as used herein can refer to human users, customers, and/or machine users of a networked solution involving the Internet Of Things. The term “customer experience” as used herein can refer to an overall experience or sense of satisfaction of the administrator.

The device factors, network factors, and/or application factors can independently as well as collectively influence a customer experience. In accordance with embodiments disclosed herein, a centralized universal key performance indicator (UKPI) engine can collect, analyze, visualize, report, and/or audit one or more of the factors given the specifics of the device types and the network (e.g., network carrier), and produce a universal key performance indicator, as described in detail below. The devices that make up the Internet of Things can be wired and/or wirelessly connected.

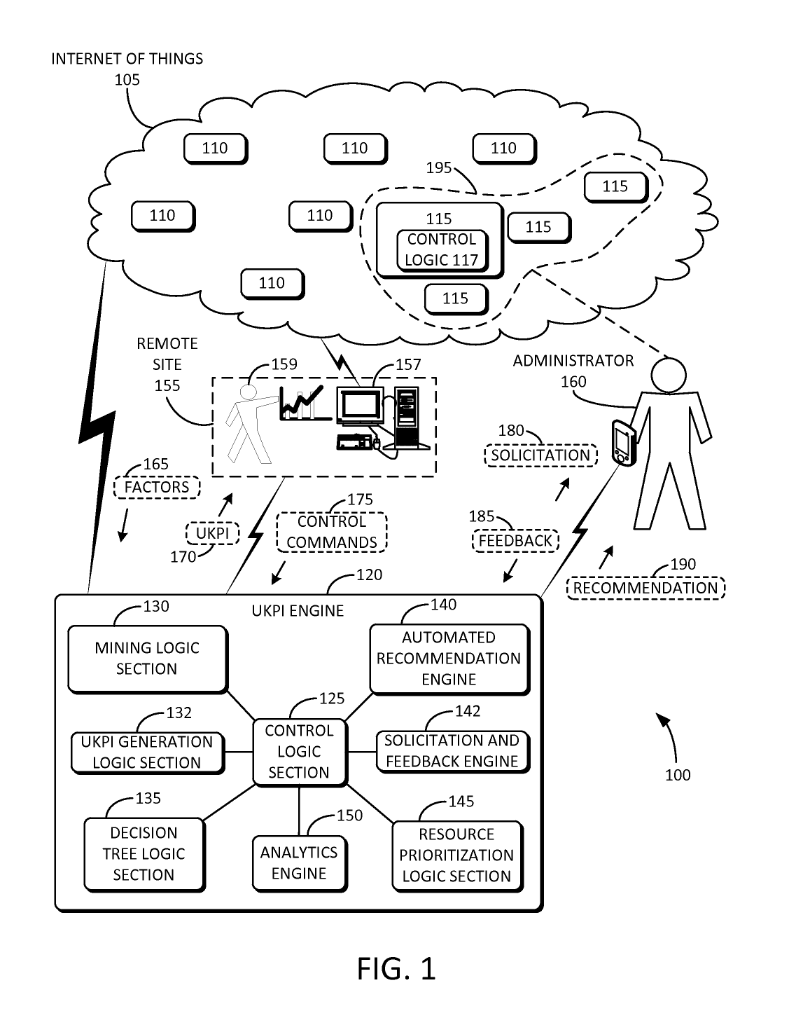

FIG. 1 illustrates a schematic diagram 100 of the Internet of Things 105 and associated universal key performance indicator (UKPI) engine 120 in accordance with various embodiments of the inventive concept. The Internet of Things 105 can include a variety of things or devices (e.g., 110 and 115). A subset (e.g., 195) of the devices can be owned or otherwise managed by one or more administrators 160. Although a certain number of the devices 110 and 115, and the subset 195 of the devices, is shown, it will be understood that these are representative of any number of devices, which can number even in the thousands, millions, or billions of devices, and so forth. The UKPI engine 120 can include or otherwise reside on one or more computing devices such as one or more computer servers, one or more network devices, one or more devices within the Internet of Things, or the like. The UKPI engine 120 can be communicatively coupled to the Internet of Things 105 including the devices 110 and 115. Alternatively or in addition, the UKPI engine 120 can be communicatively coupled to the subset 195 of devices. The UKPI engine 120 can include a mining logic section 130 that is communicatively coupled to the control logic section 125, and can mine for device factors, network factors, and application factors (e.g., 165) associated with a subset 195 of devices within the Internet of Things 105, as further described below.

The UKPI engine 120 can be communicatively coupled to a remote site 155. The remote site 155 can include a remote server 157 and/or one or more engineers or support personnel 159. Although the term “remote” is used, in some embodiments, this may indicate that the UKPI engine 120 is separate from the server 157. In other words, the UKPI engine 120 and the server 157 can be separate but reside in the same building. Alternatively, the UKPI engine 120 can be geographically remote from the remote site 155.

The UKPI engine 120 can include control logic 125 and a UKPI generation logic section 132, which can generate a UKPI 170. It will be understood that one or more UKPI 170 can be generated. Each UKPI 170 can be associated with a particular device or a particular group of devices associated with the Internet of Things 105. The UKPI 170 can be associated with the subset 195 of devices and can be generated based at least on the mined device factors, network factors, and/or application factors (e.g., 165), as further described below. The control logic section 125 can cause the UKPI 170 to be transmitted to the remote site 155. For example, the UKPI 170 can be transmitted to the remote server 157. The UKPI control logic section 125 can receive one or more control commands 175 from the remote site 155, e.g., from the remote server 157.

It is impractical for humans to individually analyze each of the factors and associated variables for tens of thousands to millions of devices. As such, in accordance with embodiments of the invention described herein, an analytics technique can be employed against the data to derive the UKPI 170, which can indicate the likelihood of an end customer (e.g., one or more administrators 160) having a positive customer experience and a high level of satisfaction with a particular solution. The term “universal” as used in UKPI can mean that the key performance indicator is comprehensive for a given portion (e.g., 195) of the Internet of Things 105 that is associated with a given solution. The portion 195 can be significant and sometimes vast.

Humans in a technical support or engineering role (e.g., 159) can use the UKPI 170 to focus their attention on improving the customer experience for the one or more administrators 160 when the UKPI 170 for given customers and/or devices crosses (e.g., falls below or rises above) a predefined threshold. In addition or alternatively, humans in a technical support or engineering role (e.g., 159) can use the UKPI 170 to assign lower priorities to servicing certain devices that have a UKPI score that crosses (e.g., falls below or rises above) a predefined threshold. In addition or alternatively, when the UKPI 170 for given customers and/or devices crosses (e.g., falls below or rises above) a predefined threshold, the remote server 157, being connected to the Internet of Things 105, can automatically apply corrective actions, such as initiating a device reboot of one or more of the devices 115, switching a cellular carrier network of one or more of the devices 115, loading a new configuration onto one or more of the devices 115, or the like. In addition or alternatively, when the UKPI 170 for given customers (e.g., 160) and/or devices (e.g., 115) crosses (e.g., falls below or rises above) a predefined threshold, a trigger may cause humans (e.g., 159 and/or 160) to be alerted, for example, by an audible alert, a visual alert, an email, a short message service (SMS) message, an automated phone call, a mobile application running on a smart phone, a tablet, and/or a personal computer, or the like.

The UKPI engine 120 can include an analytics engine 150 that is coupled to the control logic section 125. The analytics engine 120 can receive and analyze the mined device factors, the mined network factors, and/or the mined application factors (e.g., 165) for the subset 195 of devices. The analytics engine 120 can analyze the mined data to assist the UKPI generation logic section 132 in determining the UKPI 170. The UKPI engine 120 can include a solicitation and feedback engine 142, which can be coupled to the control logic section 125. The solicitation and feedback engine 142 can automatically generate one or more solicitations 180 for feedback about a particular solution from one or more administrators 160 of the subset 195 of devices. The one or more solicitations 180 can be in the form of an email, an SMS message, a phone call, a mobile application running on a smart phone, a tablet, and/or a personal computer, or the like. The solicitation and feedback engine 142 can receive feedback 185 from the one or more administrators 160 about the particular solution.

The UKPI 170 can be derived at least in part via the use of the analytics engine 150 and/or the solicitation and feedback engine 142 by employing a learning mathematical technique to the raw data inputs. An example mathematical technique well suited to the task is Bayesian statistics. In addition to the raw inputs (e.g., factors 165), users such as the one or more administrators 160 of the system can be provided with the ability to influence the UKPI 170 by hinting to the logic of the analytics engine 150 that they are becoming more or less satisfied with the performance of their system and/or solution. These hints can be in the form of the feedback 185 into the learning technique to improve its accuracy specific to the individualized needs of specific customers. Other probability functions and logic may alternatively be used to normalize or provide information to the UKPI engine 120 to adjust or derive the UKPI 170. Such techniques are particularly advantageous in a network operations center (NOC) environment to provide an actionable metric for the one or more administrators 160 or other management personnel. It allows for managed services to control all aspects of a solution.

Moreover, the solicitation and feedback engine 120 can be used to negotiate a service level agreement (SLA) between the remote site 155 and the one or more administrators 160. For example, the support personnel (e.g., engineer 159) can provide the UKPI 170 and related technical support to the one or more administrators 160 for the benefit of the administrator's subset 195 of devices, in exchange for an agreed upon service fee. The service fee can be negotiated according to the level and quantity of information and support provided by the remote site 155 to the one or more administrators 160 and that organization.

The UKPI engine 120 can include a decision tree logic section 135 that can be coupled to the control logic section 125. The decision tree logic section 135 can cause at least one decision to be made based at least on the mined device factors, the mined network factors, and/or the mined application factors (e.g., 165) for the subset 195 of devices. For example, the decision tree logic section 135 can determine how to address a particular customer issue given a particular problem, and assist in selecting a particular solution.

The UKPI engine 120 can include a resource prioritization logic section 145 that can be coupled to the control logic section 125. The resource prioritization logic section 145 can prioritize at least one resource based at least on the mined device factors, the mined network factors, and/or the mined application factors (e.g., 165). For example, the resource prioritization logic section 145 can prioritize the attention of the engineer 159 or other support personnel to a particular customer problem. Alternatively or in addition, the resource prioritization logic section 145 can prioritize the deployment of new computer hardware, software patches, or the like.

The UKPI engine 120 can include an automated recommendation engine 140 that can be coupled to the control logic section 125. The automated recommendation engine 140 can generate one or more recommendations 190 for an administrator based at least on the mined device factors, the mined network factors, and/or the mined application factors (e.g., 165). The one or more recommendations 190 can be made in the form of an email, an SMS message, a phone call, a mobile application running on a smart phone, a tablet, and/or a personal computer, or the like. The one or more recommendations 190 can be produced and sent automatically by the UKPI engine 120.

For example, the one or more recommendations 190 can include a recommended modification to an application running on the subset 195 of devices responsive to the UKPI 170 crossing a predefined threshold. Alternatively or in addition, the one or more recommendations 190 can include a recommended system configuration update to the subset 195 of devices responsive to the UKPI 170 crossing a predefined threshold. Alternatively or in addition, the one or more recommendations 190 can include a recommended firmware update to the subset 195 of devices responsive to the UKPI 170 crossing a predefined threshold. Alternatively or in addition, the one or more recommendations 190 can include a recommended change to a wireless or cellular carrier rate plan for the subset 195 of devices responsive to the UKPI 170 crossing a predefined threshold.

One or more of the devices 115 can include control logic 117. The control logic 117 can include some or all of the capabilities of the control logic 125 of the UKPI engine 120. In addition, some or all of the elements of the UKPI engine 120 (e.g., 130, 132, 135, 140, 142, 145, and/or 150) can be included in one or more of the devices 115. In other words, some or all of the functionality of the UKPI engine 120 can be distributed across multiple devices 115. Moreover, the control logic 117 on the individual devices 115 can perform time domain sampling of the device factors and/or the network factors. In addition, the control logic 117 on individual devices 115 can perform frequency domain sampling of the device factors and/or the network factors. The sampled device factors and/or the sampled network factors can be aggregated and received (e.g., factors 165) by the UKPI engine 120, and/or directly received by the remote site 155.

The one or more administrators 160 can include one administrator working for or representing one entity and another administrator working for or representing another different entity. In other words, multiple different administrators can have access to a same subset (e.g., 195) of devices. For example, a first administrator can obtain temperature information from a set of sensors associated with the devices 115, while a second administrator can obtain temperature and wind speed information from the same set of sensors associated with the devices 115. The use of the term “administrator” can, but need not, mean that the devices 115 are owned by said administrator or entity for which the administrator works.

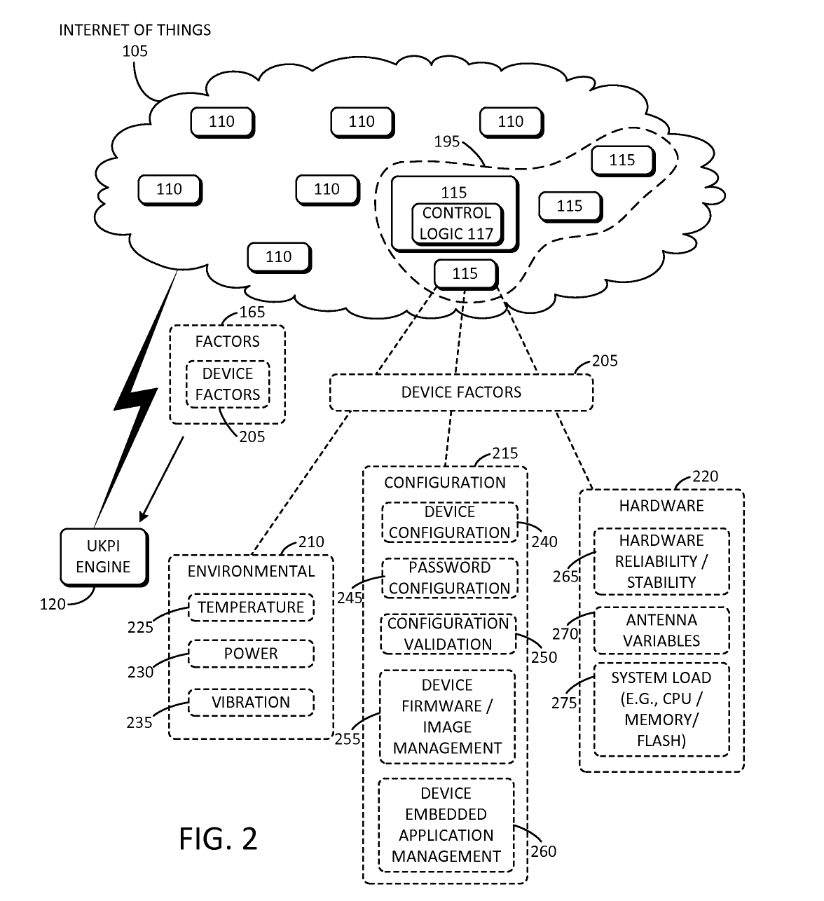

FIG. 2 illustrates a schematic diagram of the Internet of Things 105 and the associated UKPI engine 120, which can mine device factors 205 including environmental 210, configuration 215, and/or hardware 220 device factors in accordance with various embodiments of the inventive concept. Within each category, a number of variables can describe the current state of the devices. The device factors 205 can include environmental factors 210 of the subset 195 of devices, configuration factors 215 of the subset 195 of devices, and/or hardware factors 220 of the subset 195 of devices.

The environmental factors 210 can include temperature information 225 of the subset 195 of devices, power usage information 230 of the subset 195 of devices, and/or vibration information 235 of the subset 195 of devices. The configuration factors 215 can include device configuration information 240 of the subset 195 of devices, password configuration information 245 of the subset 195 of devices, configuration validation information 250 of the subset 195 of devices, device firmware image management information 255 of the subset 195 of devices, and/or device embedded application management information 260 of the subset 195 of devices. The hardware factors 220 can include hardware reliability and stability information 265 of the subset 195 of devices, antenna variable information 270 of the subset 195 of devices, and/or system load information 275 of the subset 195 of devices. For example, the system load information 275 can include central processor unit (CPU) load, volatile memory load, non-volatile memory load (e.g., flash memory, magnetic media, etc.), network load, or the like.

The mining logic section 130 of the UKPI engine 120 can mine (e.g., “poll”) for the device factors 205 associated with the subset 195 of devices within the Internet of Things 105. Alternatively or in addition, the control logic 117 of the devices 115 can actively “push” information including the device factors 205 to the UKPI engine 120. Alternatively or in addition, the UKPI engine 120 can receive the device factors 205 in an exemption driven manner. Alternatively or in addition, the mining logic section 130 can mine for device factors for other devices (e.g., 110) within the Internet of Things 105. Alternatively or in addition, the mining logic section 130 can mine for device factors for substantially all accessible devices (e.g., 110 and 115) within the Internet of Things 105.

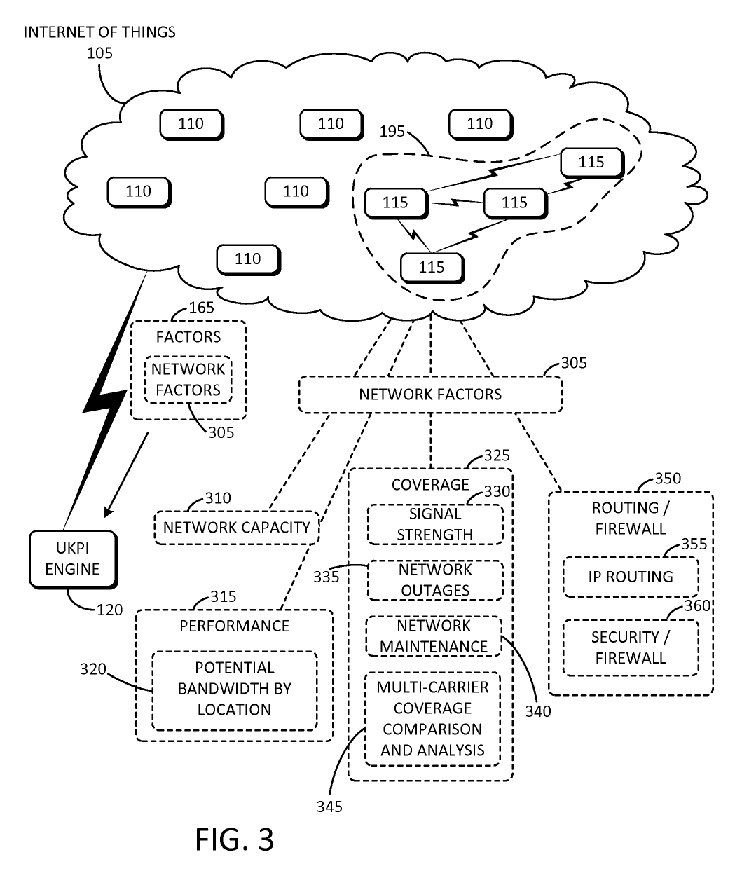

FIG. 3 illustrates a schematic diagram of the Internet of Things 105 and the associated UKPI engine 120, which can mine network factors 305 including network capacity 310, network performance 315, network coverage 325, and/or routing and firewall network factors 350 in accordance with various embodiments of the inventive concept.

Within each category, a number of variables can describe the current state of the network. The network factors 305 can include network capacity information 310 of the subset 195 of devices, performance information 315 of the subset 195 of devices, coverage information 325 of the subset 195 of devices, and/or routing and firewall information 350 of the subset of devices.

The performance information 315 of the subset 195 of devices can include potential bandwidth by location information 320 of the subset 195 of devices. The coverage information 325 of the subset 195 of devices can include signal strength information 330 of the subset 195 of devices, network outage information 335 of the subset 195 of devices, network maintenance information 340 of the subset 195 of devices, and/or multi-carrier coverage comparison and analysis information 345 for the subset of devices. The multi-carrier coverage comparison and analysis information 345 can pertain to wireless or cellular multi-carrier coverage and analysis, signal quality (e.g., signal to noise ratio), cellular carrier, signal strength, network type (e.g., LTE, evolution data optimized (EVDO), global system for mobile telecommunication (GSM), enhanced data GSM environment (EDGE), WiMax, etc.), or the like. The routing and firewall information 350 of the subset 195 of devices can include internal protocol (IP) routing information 355 for the subset 185 of devices and secure firewall information 360 of the subset 195 of devices.

The mining logic section 130 of the UKPI engine 120 can mine (e.g., “poll”) for the network factors 305 associated with the subset 195 of devices within the Internet of Things 105. Alternatively or in addition, the control logic 117 of the devices 115 can actively “push” information including the network factors 305 to the UKPI engine 120. Alternatively or in addition, the UKPI engine 120 can receive the network factors 305 in an exemption driven manner. Alternatively or in addition, the mining logic section 130 can mine for network factors for other devices (e.g., 110) within the Internet of Things 105. Alternatively or in addition, the mining logic section 130 can mine for network factors for substantially all accessible devices (e.g., 110 and 115) within the Internet of Things 105.

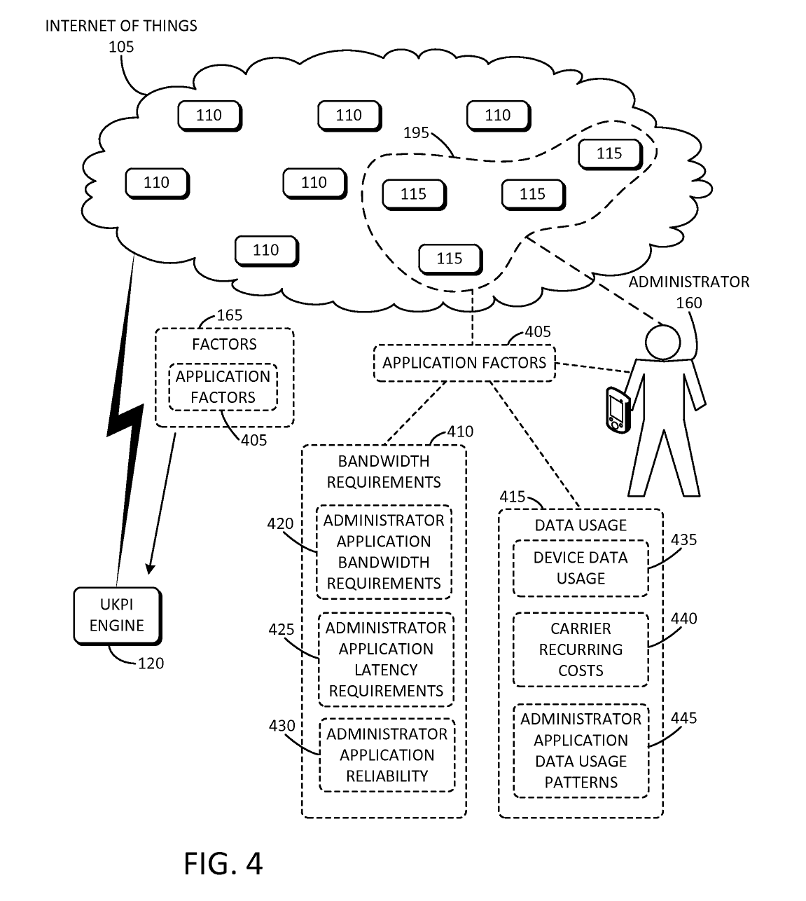

FIG. 4 illustrates a schematic diagram of the Internet of Things 105 and the associated UKPI engine 120, which can mine application factors 405 including bandwidth requirements 410 and data usage 415 in accordance with various embodiments of the inventive concept.

Within each category, a number of variables can describe the current state of the applications. The application factors 405 and/or solution factors can include bandwidth requirements 410 of the subset 195 of devices and/or data usage factors 415 of the subset 195 of devices. The bandwidth requirements 410 can include administrator application bandwidth requirements 420 for the subset 195 of devices, administrator application latency requirements 425 for the subset of devices, and/or administrator application reliability 430 requirements for the subset of devices. The data usage factors 415 can include device data usage information 435 of the subset 195 of devices, cellular carrier recurring cost information 440 for the subset 195 of devices, and/or administrator application data usage pattern information 445 of the subset 195 of devices, network, and applications.

The mining logic section 130 of the UKPI engine 120 can mine for the application factors 405 associated with the subset 195 of devices within the Internet of Things 105. Alternatively or in addition, the one or more administrators 160 can directly provide some or all of the application factors 405 via feedback (e.g., 185) to the UKPI engine 120. Alternatively or in addition, the mining logic section 130 can mine for application factors for other devices (e.g., 110) within the Internet of Things 105. Alternatively or in addition, the mining logic section 130 can mine for application factors for substantially all accessible devices (e.g., 110 and 115) within the Internet of Things 105.

As can be seen in FIGS. 2-4, different variables can be categorized and associated with each of the factors or factor types. Within each category, a number of variables can describe the current state of the devices 115, the associated network or networks, and/or the associated applications. Any individual or combination of factors as identified in the FIGS. 2-4 above can result in a negative customer experience, a positive customer experience, a satisfaction level, or the like, with a particular solution. The UKPI engine 120 can be used to mitigate the negative customer experience, reinforce the positive customer experience, determine the satisfaction level, and assist in applying the particular solution.

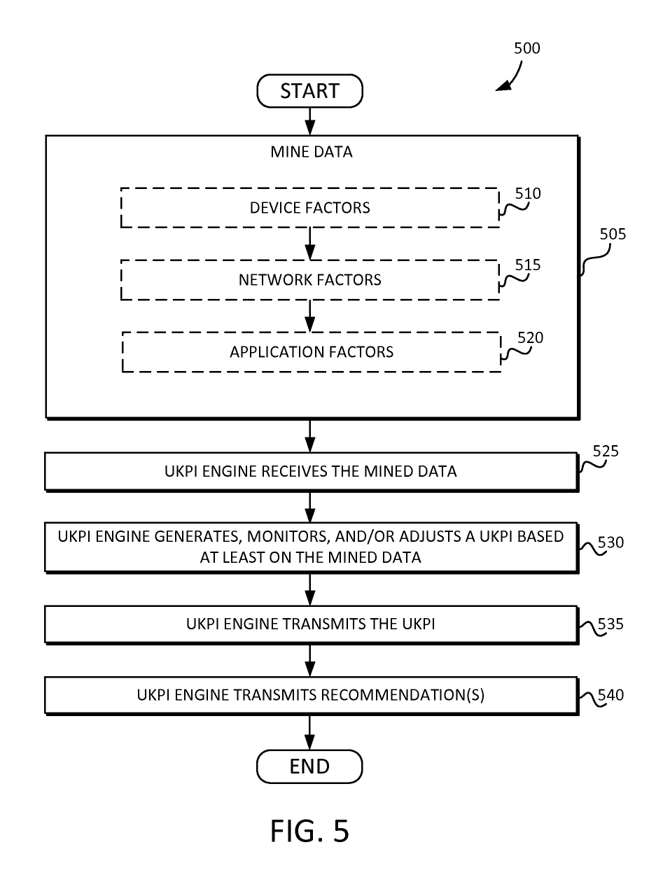

FIG. 5 shows a flow diagram 500 illustrating a technique for generating, monitoring, and/or adjusting a UKPI in accordance with embodiments of the invention disclosed herein. The technique begins at 505, where data is mined from the Internet Of Things. The mining at 505 can include mining for device factors at 510, network factors at 515, and/or application factors at 520. At 525, the UKPI engine (e.g., 120) can receive the mined data. At 530, the UKPI engine can generate, monitor, and/or adjust the UKPI based at least on the mined data. At 535, the UKPI engine can transmit the UKPI to a remote site, to engineer or support personnel, to a remote server, and/or to an administrator. At 540, the UKPI engine can transmit one or more recommendations to the administrator. Prompt action can be taken to address dissatisfaction issues with the solution based at least on the UKPI. The prompt action can be taken automatically, for example, by autonomous machines or logic (e.g., as shown and described with reference to FIGS. 1-4 above). In addition or alternatively, the prompt action can be taken by humans (e.g., engineer 159 and/or administrator 160 of FIG. 1) to address the issues. In some embodiments, if the human or humans fail to respond in a reasonable time period (e.g., more than three days, or more than one weekday, etc.), the UKPI engine (e.g., 120 of FIG. 1) can cause the UKPI (e.g., 170 of FIG. 1) to be worsened. Conversely, if the human or humans respond promptly (e.g., within less than three days, within less than one weekday, or within less than one hour, etc.), the UKPI engine can cause the UKPI to be improved.

The UKPI 170 score or metric provides a common indicator from which decisions can be made. Extremely large networks can be more efficiently monitored and managed using the techniques described herein. Decision making is facilitated that can be made independent from alerts or outages reported directly from a customer. Rather than attempting to provide managed solutions solely by humans in a post-mortem scenario, the UKPI approach provides real-time capabilities in which customer dissatisfaction is quickly and proactively remedied. As customers get less satisfied, which often occurs over time, the UKPI can be scrutinized more closely. Instead of needing to focus on each individual component of the network, a manageable metric is provided, which provides broad insight into the overall workings of a particular solution.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Embodiments of the invention may include a non-transitory machine-readable medium comprising instructions executable by one or more processors, the instructions comprising instructions to perform the elements of the inventive concepts as described herein.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A universal key performance indicator engine associated with an Internet of Things, the universal key performance indicator engine comprising:
a control logic section;
a mining logic section coupled to the control logic section and configured to mine for device factors and network factors associated with a subset of devices within the Internet of Things; and
a universal key performance indicator logic section coupled to the control logic section and configured to generate a universal key performance indicator associated with the subset of devices based at least on the mined device factors and the mined network factors.

2. The universal key performance indicator engine of claim 1, further comprising:
an analytics engine coupled to the control logic section and configured to receive and analyze the mined device factors and the mined network factors for the subset of devices;
a decision tree logic section coupled to the control logic section and configured to cause at least one decision to be made based at least on the mined device factors and the mined network factors for the subset of devices;
a resource prioritization logic section coupled to the control logic section and configured to prioritize at least one resource based at least on the mined device factors and the mined network factors; and
an automated recommendation engine coupled to the control logic section and configured to generate one or more recommendations for an administrator based at least on the mined device factors and the mined network factors.

3. The universal key performance indicator engine of claim 2, wherein:
the mining logic section is further configured to mine for application factors associated with the subset of devices within the Internet of Things;
the analytics engine is further configured to receive and analyze the mined application factors for the subset of devices;
the decision tree logic section is further configured to cause the at least one decision to be made based at least on the mined application factors for the subset of devices;
the resource prioritization logic section is further configured to prioritize the at least one resource based at least on the mined application factors;
the automated recommendation engine is further configured to generate the one or more recommendations for the administrator based at least on the mined application factors; and
the universal key performance indicator logic section is further configured to generate the universal key performance indicator associated with the subset of devices based at least on the mined application factors.

4. The universal key performance indicator engine of claim 3, wherein the application factors include bandwidth requirements of the subset of devices and data usage factors of the subset of devices.

5. The universal key performance indicator engine of claim 4, wherein the bandwidth requirements include administrator application bandwidth requirements for the subset of devices, administrator application latency requirements for the subset of devices, and administrator application reliability requirements for the subset of devices; and
wherein the data usage factors include device data usage information of the subset of devices, carrier recurring cost information for the subset of devices, and administrator application data usage pattern information of the subset of devices.

6. The universal key performance indicator engine of claim 1, wherein the device factors include environmental factors of the subset of devices, configuration factors of the subset of devices, and hardware factors of the subset of devices.

7. The universal key performance indicator engine of claim 6, wherein:
the environmental factors include temperature information of the subset of devices, power usage information of the subset of devices, and vibration information of the subset of devices;
the configuration factors include device configuration information of the subset of devices, password configuration information of the subset of devices, configuration validation information of the subset of devices, device firmware image management information of the subset of devices, and device embedded application management information of the subset of devices; and
the hardware factors include hardware reliability and stability information of the subset of devices, antenna variable information of the subset of devices, and system load information of the subset of devices.

8. The universal key performance indicator engine of claim 1, wherein the network factors include network capacity information of the subset of devices, performance information of the subset of devices, coverage information of the subset of devices, and routing and firewall information of the subset of devices.

9. The universal key performance indicator engine of claim 8, wherein:
the performance information of the subset of devices includes potential bandwidth by location information of the subset of devices;
the coverage information of the subset of devices includes signal strength information of the subset of devices, network outage information of the subset of devices, network maintenance information of the subset of devices, and multi-carrier coverage comparison and analysis information for the subset of devices; and
the routing and firewall information of the subset of devices includes internal protocol (IP) routing information for the subset of devices and secure firewall information of the subset of devices.

10. The universal key performance indicator engine of claim 1, wherein:
the control logic section is configured to cause the universal key performance indicator to be transmitted to a remote server; and
the control logic section is configured to receive one or more control commands from the remote server.

11. The universal key performance indicator engine of claim 2, wherein the one or more recommendations include a recommended modification to an application running on the subset of devices responsive to the universal key performance indicator crossing a predefined threshold.

12. The universal key performance indicator engine of claim 2, wherein the one or more recommendations include a recommended system configuration update to the subset of devices responsive to the universal key performance indicator crossing a predefined threshold.

13. The universal key performance indicator engine of claim 2, wherein the one or more recommendations include a recommended firmware update to the subset of devices responsive to the universal key performance indicator crossing a predefined threshold.

14. The universal key performance indicator engine of claim 2, wherein the one or more recommendations include a recommended change to a carrier rate plan for the subset of devices responsive to the universal key performance indicator crossing a predefined threshold.

15. The universal key performance indicator engine of claim 1, further comprising:
a solicitation and feedback engine coupled to the control logic section and configured to generate one or more solicitations for feedback about a particular solution from an administrator of the subset of devices, and to receive feedback from the administrator about the particular solution,
wherein the solicitation and feedback engine is configured to negotiate a service level agreement with the administrator.

16. A method for generating a universal key performance indicator associated with a subset of devices within an Internet of Things, the method comprising:
mining device factors and network factors associated with a subset of devices within the Internet of Things;
receiving, by a universal key performance indicator engine, the mined device factors and the mined network factors;
generating a universal key performance indicator based at least on the mined device factors and the mined network factors;
transmitting the universal key performance indicator to a remote server; and
transmitting a recommendation based at least on the universal key performance indicator to an administrator of the subset of devices.

17. The method of claim 16, further comprising:
analyzing, by an analytics engine, the mined device factors and the mined network factors for the subset of devices;
causing, by a decision tree logic section, at least one decision to be made based at least on the mined device factors and the mined network factors for the subset of devices;
prioritizing, by a resource prioritization logic section, at least one resource based at least on the mined device factors and the mined network factors;
generating, by a solicitation and feedback engine, one or more solicitations for feedback about a particular solution from the administrator of the subset of devices;
receiving feedback, by the solicitation and feedback engine, from the administrator about the particular solution;
generating, by an automated recommendation engine, one or more recommendations for the administrator based at least on the mined device factors and the mined network factors; and
generating, by the universal key performance indicator logic section, a universal key performance indicator associated with the subset of devices based at least on the mined device factors and the mined network factors.

18. The method of claim 17, further comprising:
mining application factors associated with the subset of devices;
receiving, by the universal key performance indicator engine, the mined application factors;
generating the universal key performance indicator based at least on the mined application factors;
analyzing, by the analytics engine, the mined application factors for the subset of devices;
causing, by the decision tree logic section, the at least one decision to be made based at least on the mined application factors for the subset of devices;
prioritizing, by the resource prioritization logic section, the at least one resource based at least on the mined application factors;
generating, by the automated recommendation engine, the one or more recommendations for the administrator based at least on the mined application factors; and
generating, by the universal key performance indicator logic section, the universal key performance indicator associated with the subset of devices based at least on the mined application factors.

19. The method of claim 18, wherein:
the application factors include bandwidth requirements of the subset of devices and data usage factors of the subset of devices;
the bandwidth requirements include administrator application bandwidth requirements for the subset of devices, administrator application latency requirements for the subset of devices, and administrator application reliability requirements for the subset of devices; and
the data usage factors include device data usage information of the subset of devices, carrier recurring cost information for the subset of devices, and administrator application data usage pattern information of the subset of devices.

20. The method of claim 16, wherein:
the device factors include environmental factors of the subset of devices, configuration factors of the subset of devices, and hardware factors of the subset of devices;
the environmental factors include temperature information of the subset of devices, power usage information of the subset of devices, and vibration information of the subset of devices;
the configuration factors include device configuration information of the subset of devices, password configuration information of the subset of devices, configuration validation information of the subset of devices, device firmware image management information of the subset of devices, and device embedded application management information of the subset of devices;
the hardware factors include hardware reliability and stability information of the subset of devices, antenna variable information of the subset of devices, and system load information of the subset of devices;
the network factors include network capacity information of the subset of devices, performance information of the subset of devices, coverage information of the subset of devices, and routing and firewall information of the subset of devices;
the performance information of the subset of devices includes potential bandwidth by location information of the subset of devices;
the coverage of the subset of devices includes signal strength information of the subset of devices, network outage information of the subset of devices, network maintenance information of the subset of devices, and multi-carrier coverage comparison and analysis information for the subset of devices; and
the routing and firewall information of the subset of devices includes internal protocol (IP) routing information for the subset of devices and secure firewall information of the subset of devices.
